(19) United States
(12) Patent Application Publication
(10) Pub. No.: US 2007/0209251 A1
(43) Pub. Date: Sep. 13, 2007

(54) Multifunction image display device

(76) Inventors: Jenny Zheng, Northville, MI (US); Bin Hong, Novi, MI (US)

Correspondence Address: Bin Hong, 45169 Roundview Dr., Novi, MI, 48375, US

(21) Appl. No.: 11/315,735

(22) Filed: Dec. 23, 2005

(51) Int. Cl. G09F 11/18

(52) U.S. Cl. 40/471; 40/472

(57) ABSTRACT

A multifunction image display device that consists of an image display device (such as televisions, computer monitors, billboards etc.) and an integrated retractable static visual display utilizes the display panel area to present static visual image such as decorative art works, and can fully address the dull idle screen problem by utilizing the frame of the image display device and an integrated retractable and replaceable visual display to serve as a conventional picture-frame while the image display device is not in use, and to serve as a image screen while the image display device is in use. The static visual display is made of a sheet material having decorative art woks. In additional to the basic components of an image display device, this device comprises a base that acts as the carrier for the static visual display, a replaceable static visual display and features such as gap and channels defined between the front portion of the housing and the display panel to conceal the associated components and to allow the base and sheet material passing through. The base comprises a shaft driven by a motor, strings and guiding shafts and rollers, two pieces of fabric and one or two rigid bars. Tensioning mechanism is constructed to ensure acceptable flatness of the sheet material. The display system has normal operation mode and static visual display replacement mode. Position switches or encoder are utilized to deactivate the rotational movement of the shaft driven by the motor in normal operation mode.

### CROSS-REFERENCE TO RELATED APPLICATIONS

U.S. Patent Documents

| | | |
|---|---|---|
| 5138462 | August, 1992 | Skovgaard |
| 5199697 | April, 1993 | Yamada et al. |
| 5199773 | April, 1993 | Price, Jr. et al. |
| 5264765 | November, 1993 | Pecorino |
| 5720137 | February, 1998 | Rodriquez |
| 6070642 | June, 2000 | Douglas et al. |
| 6846083 | January, 2005 | Mylar |
| 6901987 | June, 2005 | Graham |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to a multifunction image display device and, more particularly, to a multifunction image display device having an image display device (such as televisions, computer monitors, billboards etc.) and an integrated retractable static visual display, arranged in front of display panel of said image display device, for displaying a static visual image while said image display device is not in use.

2. Description of the Related Art

Image display devices such as televisions, computer monitors, billboards, etc. provide visual information when in use. They, however, leave blank area and serve little purpose when not in use. The blank area becomes much duller and aesthetically undesirable as screen size increases in recent years.

There have been attempts to cover television screen in particular.

U.S. Pat. No. 6,901,987 entitled furled decorative covering apparatus and method to Graham discloses a frame with furled decorative cover. The frame can be used to cover objects such as flat screen television. This invention provides an external means to cover the display and the said means takes additional space, adds additional parts and costs, and alters the environment for which the display unit was designed for.

U.S. Pat. No. 5,138,462 entitled TV-set having screen covering means to Skovgaard discloses a television set with a cabinet, a picture screen accommodated in the cabinet, a cover element connected to the cabinet. The cover is positioned over a front of the picture screen for covering the same when the set is not in use along with a control means to actuate, in response to the switching on of the television set, a removal of the cover element from the picture screen with such a delay that the actuation is initiated only after a picture has been fully established on the picture screen. This invention requires the screen cover to be connected to and contained within the cabinet that limits its use.

As a result, there is a need for a multifunction image display device that can fully address the dull idle screen problem by utilize the frame of the image display device and an integrated retractable and replaceable visual display to serve as a conventional picture-frame while the image display device is not in use, and served as a image screen while the image display device is in use. Such a device is simple and cost effective, and aesthetically appealing.

### BRIEF SUMMARY OF THE INVENTION

This invention discloses a multifunction image display device that consists of an image display device and an integrated retractable static visual display to utilize the display panel area to present static visual image such as decorative art works while the image display device is not in use. The static visual display is made of a sheet material having decorative art works. It not only eliminates the dull look of the idle screen but also enhances the visual appearance of the image display device with the static visual display. Another advantage of this device is that the front portion of the housing can be designed to possess desired style and characteristics.

In additional to the basic components of an image display device, this device comprises a base, a replaceable static visual display and features such as gap and channels defined between the front portion of the housing and the display panel.

The base acts as the carrier for the sheet material having static visual image, and the sheet material is detachably attached to the base by two coupling means, such as conventional zippers. The base comprises a shaft driven by a motor, strings and guiding shafts and rollers, two pieces of fabric and one or two rigid bars. One piece of fabric with one end connecting to the shaft, the two opposite sides connecting to portion of the two strings at one end and the other end detachably connecting to the sheet material is used as a connecting member for the sheet material. The other ends of the strings are connected to and looped around the shaft. A rigid bar and another piece of fabric are connected together with the piece of fabric detachably connecting to the sheet material by a coupling means and the rigid bar connecting to the strings to ensure the sheet material having uniform tension. The rigid bar is detachably connected to the two strings by the connecting means. The guiding rollers and shafts are used to support the base and ensure the portion of the base moves parallel to the display panel when it moves in front of the display panel.

A sheet material with static visual image is detachably attached to the base through the two coupling means on the opposite sides. The length of the sheet material is slightly shorter than the distance between the two coupling means on the base; therefore, certain amount of tension is imposed to the sheet material to ensure acceptable flatness of the sheet material as it is rolled down and revealed in front of the display panel.

A retracting mechanism is used for storing the sheet material in a wrapped orientation on the shaft when the sheet material is in the retracted position as well as for positioning the sheet material between the extended and retracted positions. In a particular embodiment of this invention, the strings of the base are connected to and looped around the shaft. The strings can be extended or retracted based on the direction of the rotation of the shaft. In another particular embodiment of this invention, the strings of the base are connected to and rolled around two spring-tensioned rollers. These tensioned rollers collect the excess strings as the sheet material is moved to cover the display panel and provide proper tension to the sheet material and strings.

To ensure aesthetical presentation of the static visual display, the front portion of the housing with features such as a gap and channels defined between the front portion of the housing and the display panel to conceal the strings, coupling and tensioning means and to allow the base and sheet material passing through is also disclosed in this invention. What is exposed is only the sheet material having static visual display and the front portion of the housing.

The range of the rotational motion of the shaft is defined through either the rotational travel of the shaft or by limit switches. The activation of the rotation is by internal signal from the image display device or by external wireless signal from a remote control. The deactivation of the rotation is by internal signal from the image display device or by rotational travel encoder or by the limit switches triggered by the base.

In a particular embodiment of this invention, position switches are placed at the “retracted” and “extended” positions to deactivate the rotational movement of the shaft. These switches can be located in the front portion of the housing and are contact sensitive. The rigid bar can be used to trigger the switches as the retractable display changes positions.

In a particular embodiment of this invention, a rotational encoder is coupled at the first rotational shaft to provide the position of the sheet material and the ability for the motor to stop at “extended” and “retracted” positions and any positions in between.

There are two modes of operation: a normal operation mode and a sheet material replacement mode. 1) In the normal operation mode, the motor is controlled by a switch on the image display device and/or external wireless signal. When “extend” signal is received, the motor is activated and starts rotation in the first direction. The motor will stop operation automatically when the switch designed for the “extended” position is triggered by the rigid bar or the rotational encoder reaches the “extended” position. When “retract” signal is received, the motor is activated and starts rotation in the second direction. The motor will stop operation automatically when the switch designed for the “retracted” position is triggered by the rigid bar or the rotational encoder reaches the “retracted” position. 2) In the sheet material replacement mode, the motor is controlled manually. When manual control signal is received from the switch or the control unit of the display or external wireless signal, the motor will rotate in the direction based on the signal and will stop operation when the control signal is off. In this mode, the sheet material can be placed at any location and the coupling means of the sheet material and the rigid bar can be exposed for replacing the sheet material.

The shaft is mounted on the supporting member of the image display device. A side access panel is allocated on the outer housing of the image display device for maintenance and repair of the retractable display system.

This invention provides a means to conceal the idle image screen with a retractable static visual display as an integral part of the image display device. It eliminates the dull appearance of an idle image screen and beautifies the surrounding with decorative static image of choice. The static visual display is replaceable through convenient attachment means.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic perspective view of a multifunction image display device when the display is in extended position according to the present invention.

FIG. 2 is a schematic perspective view of an integrated retractable static visual display when the display is in extended position according to the present invention.

FIG. 3 is a schematic perspective exploded view of shafts, mounting, and a motor of a preferred embodiment according to the present invention.

FIG. 4 is a schematic perspective exploded view of shafts, mounting, and a motor of another preferred embodiment according to the present invention.

FIG. 5 is a schematic perspective view with indications for section views of a multifunction image display device according to the present invention.

FIG. 5A is an elevational cross-sectional view at section 5A of a multifunction image display device according to the present invention.

FIG. 5B is an elevational cross-sectional view at section 5B of a multifunction image display device according to the present invention.

FIG. 5C is an elevational cross-sectional view at 5C of a multifunction image display device according to the present invention.

FIG. 6 illustrates an overall cross-sectional view at string location of a multifunction image display device according to the present invention.

FIG. 7 illustrates an overall cross-sectional view at string location of a multifunction image display device of another preferred embodiment according to the present invention.

FIG. 8 is a schematic perspective view of an integrated retractable static visual display when the display is between extended and retracted position according to the present invention.

FIG. 9 is a schematic perspective view of an integrated retractable static visual display when the display is in retracted position according to the present invention.

FIG. 10 is a schematic view of a remote control for controlling the integrated retractable static visual display wirelessly.

### DETAILED DESCRIPTION

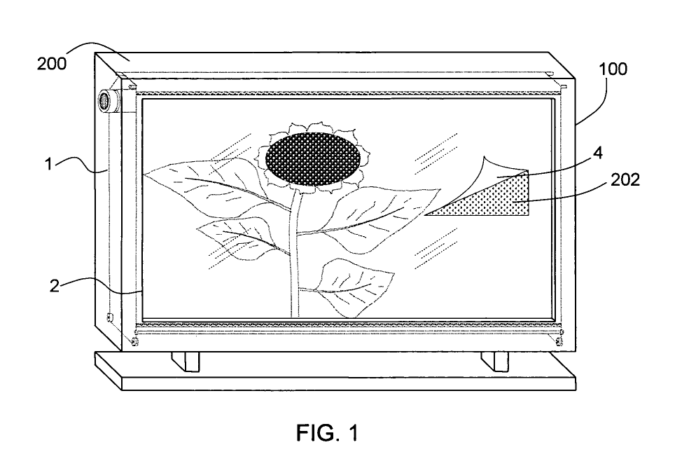

FIG. 1 illustrates a multifunction image display device 100 having an image display device 200 (such as televisions, computer monitors, billboards etc.) and an integrated retractable static visual display 1, the integrated retractable static visual display 1 is in extended position. The sheet material 4 is in front of the image screen 202. The front portion of housing 2 of the image display device 100 conceals the retractable static visual display 1 except the portion with the static visual image.

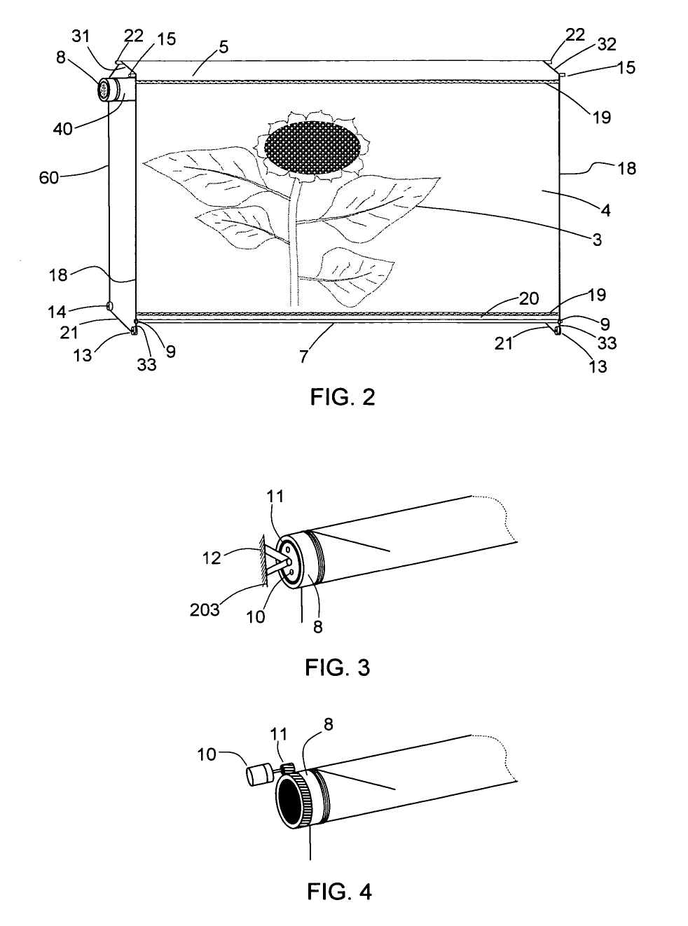

FIG. 2 illustrates the integrated retractable static visual display 1 having a sheet material 4 having static visual image 3. The sheet material 4 may be made of a variety of different materials. As illustrated, the top of the sheet material 4 is attached to one end of first connecting member 5, such as a piece of fabric material, and the other end of the first connecting member is connected to the first elongate shaft 8. A conventional zipper 19 may be used to connect the top of the sheet material 4 and the bottom of the first connecting member 5, with one part of the zipper 19 coupled to the top portion of the sheet material 4, and the other part of the zipper 19 coupled to the bottom portion of the first connecting member 5. In the same way, a conventional zipper 19 may also be used to connect the bottom of the sheet material 4 and the top portion of the second connecting member 20, such as a piece of fabric, with one part of the zipper 19 coupled to the bottom portion of the sheet material 4, and the other part of the zipper 19 coupled to the top portion of the second connecting member 20. The first rigid bar 7 is connected to the bottom portion of the second connecting member 20, and detachably attached to one end of a plurality of the third connecting members 21, such as ropes and strings, by the fourth attaching means 9, the other end of a plurality of the third connecting member 21 is connected to the first elongate shaft 8.

A retracting mechanism 40 is disposed inside the housing 2. The retracing mechanism 40 is for storing the sheet material 4 in a wrapped orientation when the sheet material 4 is in the retracted position as well as for positioning the sheet material 4 between the extended and retracted positions. The retracting mechanism 40 comprises the first shaft 8 disposed inside the housing 2 allowing rotation of the shaft 8, the top end of the first connecting member 5 is coupled to the first shaft 8. The sheet material 4 wraps around the first shaft 8 as the sheet material 4 moves from the extended position towards the retracted position. The shaft 8 is able to rotate in a first direction and a second direction. The shaft 8 moves in the first direction as the sheet material moves towards an extended position. The shaft 8 moves in a second direction as the shaft 8 moves towards a retracted position.

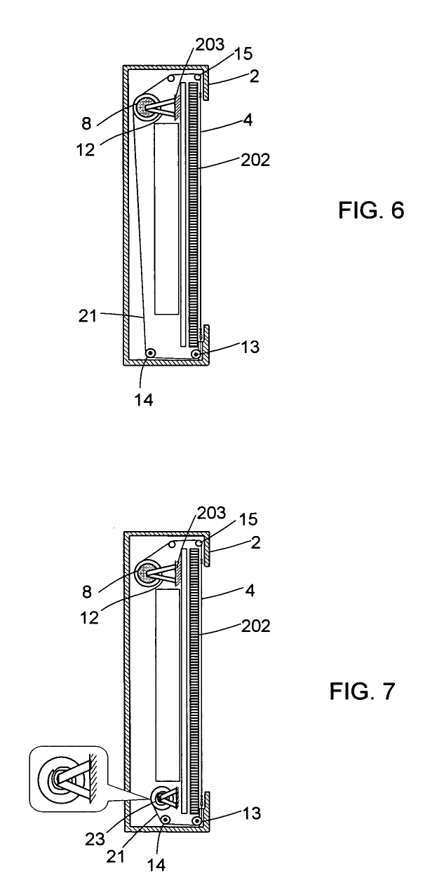

Ideally, the retracting mechanism 40 further comprises a motor 10 mounted either inside the shaft 8 (illustrated in FIG. 3) or outside the shaft 8 (illustrated in FIG. 4) that has an output shaft 11, and this output shaft 11 connects to and drives the shaft 8. The shaft 8 is connected to the first mounting 12 that attaches to the supporting member 203 of the image display device 200 (illustrated in FIG. 6).

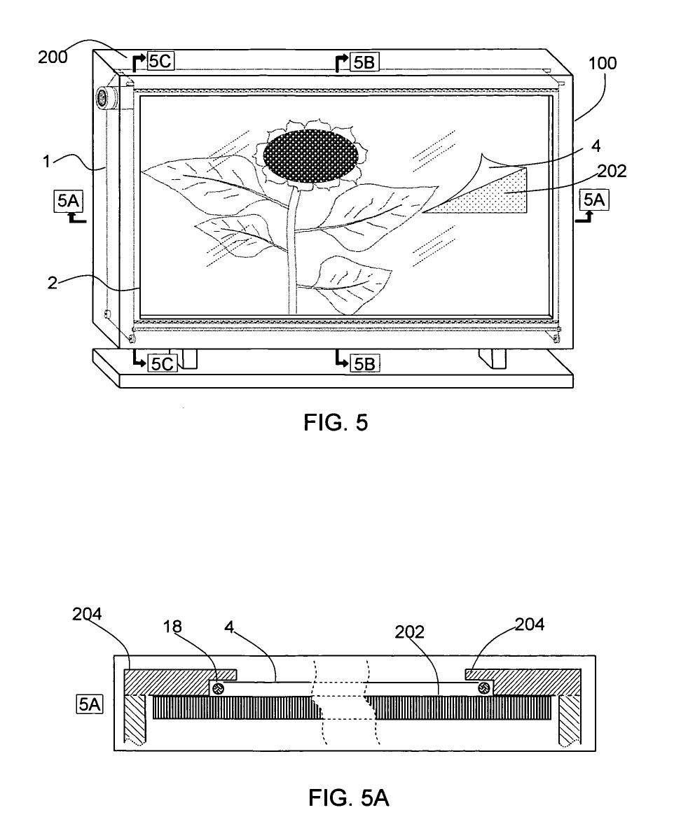

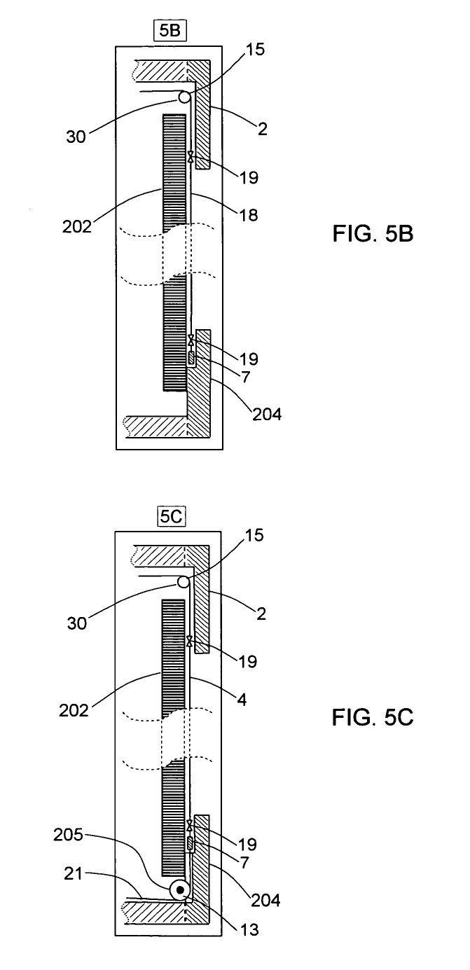

FIGS. 5B and 5C illustrates the cross section of the multifunction image display device 100. A gap 30 is defined between the front portion of the housing 2 and the display panel 202 at the top side of the display panel 202 to allow the sheet material 4 passing through. A plurality of channels 205 is formed in the front portion of the housing at the bottom side of the display panel, allowing the third connecting members 21 passing through.

FIG. 2 and FIG. 5C also illustrates the third connecting members 21 are supported by multiple idle rollers 13 and 14. The idle rollers 13 are positioned inside the channel 205 and adjacent to the bottom portion of the display panel 202. The first connecting member 5 is supported by the shaft 15 and the shaft 22. The second shaft 15 is positioned inside the gap 30 and adjacent to the top side of the display panel 202. The second shaft 15, together with the idle rollers 13, guides the sheet material 4 moving along the display panel 202 and through the gap 30 between the extended and the retracted positions when the shaft 8 is driven by the motor 10.

FIG. 2 also illustrates fourth connecting member 18, such as two ropes or strings, portion of the fourth connecting member 18 at one end connecting the left side 31 and the right side 32 of the first connecting member 5 respectively, the opposite end 33 of the fourth connecting member 18 connecting the top of the third connecting members 21, the first shaft 8, the first connecting member 5, the fourth connecting member 18 and the third connecting member 21 form a base 60. The length of the sheet material 4 is slightly shorter than the distance between the first connecting means 19 and the second connecting means 19 in order to impose needed tension to ensure acceptable flatness of the sheet material 4. The sheet material is detachably attached to the base by connecting the top of the sheet material 4 and the bottom of the first connecting member 5 with the first connecting means 19, such as a conventional zipper, and by connecting the bottom of the sheet material 4 and the top of the second connecting member 20 with the first connecting means 19, such as a conventional zipper.

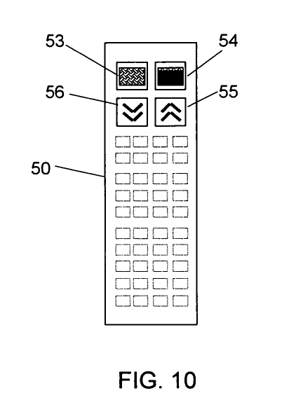

The motor 10 can also be controlled by a remote controller 50 as shown in FIG. 10 in communication with the motor 10 such as by infrared or radio waves. The remote controller 50 has one or more of the following buttons: an extended button 53 is for rotating the shaft 8 in the first direction and stopping the sheet material at the extended position for view the static visual display while the image display device is not in use, a retracted button 54 for rotating the shaft 8 in the second direction and the sheet material is wrapped around the shaft 8 while the image display device is in use to view the image, a raising button 55 is for manually rotating the shaft 8 in the second direction and stopping at any position, a lowering button 56 is for manually rotating the shaft 8 in the first direction and stopping at any position, the raising and lowering buttons are used when replacing the sheet material.

FIGS. 5A, 5B, and 5C also illustrate a feature 204 that protrudes from the left and right sides and the bottom side of the front portion of the housing 2 to conceal the left edge and right edge of the sheet material 4 and the fourth connecting members 18 and the first rigid bar 7 while sheet material 4 is disposed in front of the display panel 202 when in the extended position.

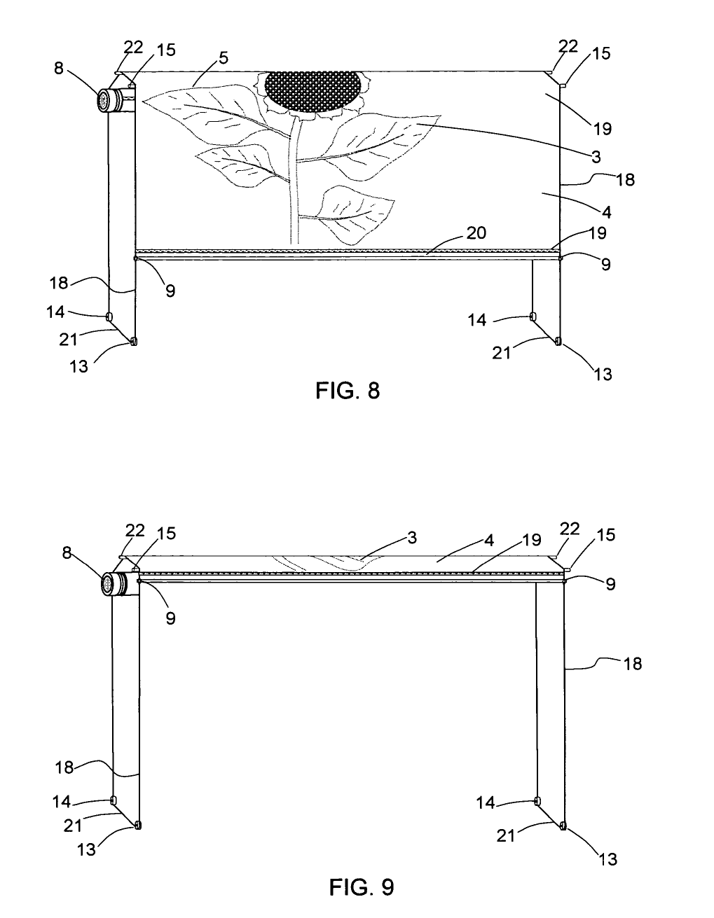

There are three positions for the sheet material 4. 1) Retracted position (illustrated n FIG. 9): in this position, the display panel 202 is fully exposed for viewing. The integrated retractable display 1 and associated parts are all concealed and not visible. 2) Extended (illustrated in FIG. 2) position: in this position, the display panel 202 is fully covered by the static visual image 3. The static visual image 3 is fully exposed but its associated parts are concealed. 3) Replacement position (illustrated in FIG. 8): in this position, the rigid bar 7 and coupling means (9, 20, and 19) are exposed for replacing the sheet material 4.

Replacement of the sheet material 4 can be achieved by taking the following steps:

First, rotate the shaft 8 so that the sheet material 4 is between the extended and retracted position (illustrated in FIG. 8), and the rigid bar 7 is exposed in front of the display panel 202.

Second, tilt the rigid bar 7 at the end of the sheet material 4 and dislocate the rigid bar 7 out of the channels 204 (illustrated in FIG. 5A) that cover the strings 18 during normal operation. The rigid bar 7 can be detached from the strings 18. The sheet material 4 is then detached from the second connecting member 20 utilizing the detaching means 19 such as zippers.

Third, rotate the sheet material 4 down so that the first connecting means 19 at the top of the sheet material 4 is accessible, then detach the sheet material 4 from the base 60 by detaching means 19 such as zipper. This step is possible since the rigid bar 7 that serves as a stopper for the travel of the base 60 is detached from the base 60. After detaching the sheet material 4 from the first connecting means 19, a new sheet material 4 can be attached to the already exposed first connecting means 19. The sides of the new sheet material 4 can be inserted into the side channels 204.

Fourth, rotate the sheet material 4 up so that the second connecting means 19 and the attachment points for the rigid bar 7 are exposed. The new sheet material 4 then can be attached to the second connecting member 20 that is connected to the rigid bar 7. The rigid bar 7 then can be attached to the attachment points on the strings 18.

Fifth, further rotate the sheet material 4 down to the end of the range as the rigid bar 7 triggers the range switch. Normal operation then can be restored.

FIG. 7 illustrates another embodiment that the third connecting member 21 is connected to a spring-tensioned roller 23. In this embodiment, the strings 21 is retracted and released from the spring-tensioned rollers 23. One of the advantages of this arrangement is that it offers the flexibility for packaging.

The orientation related descriptive words such as “up”, “upwardly”, “down”, “downwardly”, “top”, “bottom”, “left”, “right”, etc. are relative to each other. The retractable static visual display can be arranged in left-right or up-down orientations, and all these words shall be substituted among them to maintain the same relative orientation.

While this invention has been described with respect to certain specific embodiments, it is to be understood that the invention is not limited in its application to the details of construction and to the arrangements of the components set forth in the above description or illustrated in the drawings. Many modifications and changes may be made by those skilled in the art without departing from the spirit and scope of the invention.

1. A multifunction image display device comprising:
an image display device (such as televisions, computer monitors, billboards etc.) having a housing, a display panel, and supporting members, the front portion of said housing adjacent to said display panel having a top side, a bottom side, a left side, and a right side,
a sheet material having static visual image having a top side, a bottom side, a left side and a right side,
first attaching means for attaching said sheet material so that said sheet material becomes disposed in front of said display panel for displaying static visual image while said image display device is not in use,
a gap located at one side of said front portion of said housing, defined between said front portion of said housing and said display panel to allow said sheet material passing through,
driving means for moving said sheet material passing through said gap between an extended position and a retracted position.

2. The multifunction image display device of claim 1, wherein said first attaching means comprising:
a first mounting means located inside the said image display device and connected to said supporting member of said image display device,
an elongated first shaft having opposed end portions connected with said first mounting means,
second attaching means for attaching the said first shaft to said top side of said sheet material,
third attaching means for attaching said bottom side of said sheet material to the said first shaft.

3. The multifunction image display device of claim 2, wherein said second attaching means comprising:
a first connecting member having a top side, a bottom side, a left side and a right side,
a first connecting means, one of which is attached near said bottom side of said first connecting member and the other of which is attached near said top side of said sheet material.

4. The multifunction image display device of claim 2, wherein said third attaching means comprising:
a second connecting member having a top side, a bottom side, a left side and a right side,
a second connecting means, one of which is attached near said top side of said second connecting member and the other of which is attached near said bottom side of said sheet material,
a first stiff elongated bar attached to said bottom side of said sheet material, plurality of third connecting members,
a fourth attaching means to connect said first stiff elongate bar to one end of said third connecting members,
a fifth attaching means to connect said elongate first shaft to the other end of said third connecting member.

5. The multifunction image display device of claim 4, further comprising: an elongated second shaft disposed within said image display device and adjacent to said gap, said second shaft guiding the sheet material upwardly or downwardly through said gap.

6. The multifunction image display device of claim 5, further comprising: a plurality of channels located at the opposing side of said side of said front portion of said housing having said gap, defined between said front portion of said housing and said display panel, to allow said third connecting members passing through.

7. The multifunction image display device of claim 6, further comprising: a plurality of first idle rollers disposed within said image display device and adjacent to said channels, said idle rollers, together with said second shaft, guiding portion of said sheet material that is in front of said display panel moving parallel to said display panel.

8. The multifunction image display device of claim 7, further comprising: an elongated third shaft and a plurality of second idle rollers positioned within said image display device to allow flexible packaging of said first mounting means and said first shaft.

9. The multifunction image display device of claim 8, further comprising: a feature that protrudes from said side of said front portion of said housing having said channels, to conceal said first stiff elongate bar and said second connecting means while said sheet material is in said extended position.

10. The multifunction image display device of claim 1, wherein said first attaching means has tensioning means.

11. The multifunction image display device of claim 4, wherein said sheet material further comprising:
one of said first connecting means is attached to said top side of said sheet material,
one of said second connecting means is attached to said bottom side of said sheet material.

12. The multifunction image display device of claim 1, wherein said sheet material is made of a thin, flexible, and durable fabric type material.

13. The multifunction image display device of claim 3, wherein said one of said first connecting means comprising one of zipper fastener means.

14. The multifunction image display device of claim 4, further comprising fourth connecting member, portion of said fourth connecting member at one end connecting to said first connecting member, the opposite end of said fourth connecting member connecting to one end of said third connecting member, said first shaft, said first connecting member, said fourth connecting member and said third connecting member form a base that acts as a carrier for said sheet material. The length of the sheet material is slightly shorter than the distance between said first connecting means and said second connecting means in order to impose needed tension to ensure good flatness of said sheet material.

15. The multifunction image display device of claim 14, wherein said sheet material is replaceable. Said sheet material is detachably attached to said base by connecting said top side of said sheet material and said bottom side of said first connecting member with said first connecting means, and by connecting the bottom of said sheet material and the top of said second connecting member with said second connecting means.

16. The multifunction image display device of claim 1, wherein said driving means comprising:
a motor mounted in said image display device, and having an output shaft,
the output shaft of said motor connected to and driving said first shaft.

17. The multifunction image display device of claim 16, further comprising a control system to control said motor.

18. The multifunction image display device of claim 17, further comprising a wireless signal to control said motor.

19. The multifunction image display device of claim 18, further comprising control system that has normal operation mode and sheet material replacement mode.

20. The multifunction image display device of claim 19, further comprising a plurality of position switches located inside said front portion of said housing, triggered by said first elongate rigid bar to deactivate the rotational movement of said first elongate shaft.

21. The multifunction image display device of claim 15, further comprising: a feature that protrudes from said left side and said right side of said front portion of said housing, to conceal said fourth connecting member while said sheet material is in said extended position.

22. The multifunction image display device of claim 14, wherein said fourth connecting member comprising two strings with portion of said two strings at one end connecting to said left side and said right side of said first connecting member respectively, the opposite end of said two strings connecting to one end of said third connecting members.

23. The multifunction image display device of claim 2, wherein said third attaching means comprising:
a second connecting member having a top side, a bottom side, a left side and a right side,
a second connecting means, one of which is attached near said top side of said second connecting member and the other of which is attached near said bottom side of said sheet material,
a first stiff elongated bar attached to said bottom side of said sheet material,
a plurality of third connecting members,
a fourth attaching means to connect said first stiff elongate bar to one end of said third connecting members,
the other end of said third connecting members are connected to and rolled around a plurality of spring-tensioned rollers. Said tensioned rollers collect the excess said third connecting members as said sheet material is moved to said extended position and provide proper tension to said sheet material to ensure acceptable flatness.

24. A multifunction image display device comprising:
an image display device (such as televisions, computer monitors, billboards etc.) having a housing, a display panel, and supporting members, the front portion of said housing adjacent to said display panel having a top side, a bottom side, a left side, and a right side,
a sheet material having static visual image having a top side, a bottom side, a left side and a right side,
first attaching means for attaching said sheet material so that said sheet material becomes disposed in front of said display panel for displaying static visual image while said image display device is not in use,
a) a first mounting means located inside the said image display device and connected to said supporting member of said image display device,
b) an elongated first shaft having opposed end portions connected with said first mounting means,
second attaching means for attaching the said first shaft to said top side of said sheet material, further comprising:
a) a first connecting member having a top side, a bottom side, a left side and a right side,
b) a first connecting means, one of which is attached near said bottom side of said first connecting member and the other of which is attached near said top side of said sheet material,
c) one of zipper fastener means as said first connecting means connecting said sheet material,
third attaching means for attaching said bottom side of said sheet material to the said first shaft, comprising:
a) a second connecting member having a top side, a bottom side, a left side and a right side,
b) a second connecting means, one of which is attached near said top side of said second connecting member and the other of which is attached near said bottom side of said sheet material,
c) one of zipper fastener means as said second connecting means connecting said sheet material,
d) a first stiff elongated bar attached to said bottom side of said sheet material,
e) plurality of third connecting members,
a fourth attaching means to connect said first stiff elongate bar to one end of said third connecting members,
a fifth attaching means to connect said elongate first shaft to the other end of said third connecting member,
a gap located at one side of said front portion of said housing, defined between said front portion of said housing and said display panel to allow said sheet material passing through,
driving means for moving said sheet material passing through said gap between an extended position and a retracted position, comprising:
a) a motor mounted in said image display device, and having an output shaft,
b) the output shaft of said motor connected to and driving said first shaft.
c) a control system to control said motor,
a control system that has normal operation mode and sheet material replacement mode,
a wireless signal to control said motor,
a plurality of position switches located inside said front portion of said housing, triggered by said first elongate rigid bar to deactivate the rotational movement of said first elongate shaft,
an elongated second shaft disposed within said image display device and adjacent to said gap, said second shaft guiding the sheet material upwardly or downwardly through said gap,
a plurality of channels located at the opposing side of said side of said front portion of said housing having said gap, defined between said front portion of said housing and said display panel, to allow said third connecting members passing through,
a plurality of first idle rollers disposed within said image display device and adjacent to said channels, said idle rollers, together with said second shaft, guiding portion of said sheet material that is in front of said display panel moving parallel to said display panel,
an elongated third shaft and a plurality of second idle rollers positioned within said image display device to allow flexible packaging of said first mounting means and said first shaft,
a feature that protrudes from said side of said front portion of said housing having said channels, to conceal said first stiff elongate bar and said second connecting means while said sheet material is in said extended position.
